(19) United States
(12) Patent Application Publication
(10) Pub. No.: US 2011/0149175 A1
(43) Pub. Date: Jun. 23, 2011

(54) PROJECTOR AND METHOD FOR PROJECTING IMAGE

(75) Inventors: Takashi OZAWA, Shiojiri-shi (JP); Mitsuhiko IGARASHI, Matsumoto-shi (JP)

(73) Assignee: SEIKO EPSON CORPORATION, Tokyo (JP)

(21) Appl. No.: 12/969,937

(22) Filed: Dec. 16, 2010

(30) Foreign Application Priority Data
Dec. 21, 2009 (JP) 2009-288746

(51) Int. Cl. H04N 9/31

(52) U.S. Cl. 348/744; 348/E09.025

(57) ABSTRACT

A projector includes: an image projecting section that projects an image; a ruled line storage section that stores ruled line data of a ruled line; a ruled line reading unit that reads the ruled line data of the ruled line from the ruled line storage section so as to make the image projecting section project the ruled line corresponding to the ruled line data; a ruled line editing unit that performs editing for changing the structure of the projected ruled line; and a storage processing unit that makes the ruled line storage section store the edited ruled line data corresponding to the ruled line changed by the ruled line editing unit.

### CROSS-REFERENCE

The present application claims priority from Japanese Patent Application No. 2009-288746 filed on Dec. 21, 2009, which is hereby incorporated by reference in its entirety.

As a projector, there is a projector provided with an image taking section taking an image of a subject, a control section recognizing the position of a character string in the taken image of the subject and forming ruled line data constituting a table based on the recognition result, and a projecting section generating image light of the table based on the ruled line data generated by the control section and projecting the image light onto the subject (see Japanese Patent Publication No. 2008-262302 (Patent Document 1)).

Moreover, as another projector, there is a projector that can project a ruled line or the like of a previously registered template onto a whiteboard and edit the attributes, such as the thickness and color, of the ruled line or the like by using a key input section provided in the projector (see Japanese Patent Publication No. 2004-198858 (Patent Document 2)). With this projector, it is also possible to take an image of the whiteboard onto which an image is projected, send the taken image to a computer, and store the image in the computer.

However, since the projector of Patent Document 1 creates a table from a written character string, the projector does not allow the user to edit the ruled line data generated by the control section at will, and does not assume that the generated ruled line data is reused. Moreover, table creation processing and character recognition processing are complicated and sophisticated, resulting in an increase in cost. Furthermore, when the written character is bent or tilted, the ruled line spacing becomes large more than necessary.

Moreover, the projector of Patent Document 2 allows the attributes of a ruled line or the like to be edited. However, Patent Document 2 does not refer to the reuse of the edited template, and the edited ruled line is left as a taken image of the whiteboard.

### SUMMARY

Various embodiments may provide a projector that can project an intended ruled line and edit the ruled line easily, and can reuse the edited ruled line as a template.

Another embodiment may provide a method for projecting an image, the method that can edit a ruled line projected by the projector described above and reuse the edited ruled line as a template.

According to at least one embodiment of the disclosure, there is provided a projector including: an image projecting section that projects an image; a ruled line storage section that stores ruled line data of a ruled line; a ruled line reading unit that reads the ruled line data of the ruled line from the ruled line storage section so as to make the image projecting section project the ruled line corresponding to the ruled line data; a ruled line editing unit that performs editing for changing the structure of the projected ruled line; and a storage processing unit that makes the ruled line storage section store the edited ruled line data corresponding to the ruled line changed by the ruled line editing unit. Incidentally, the ruled line data is not an image itself of the ruled line, and the ruled line data is so configured as to include attribute information or elemental information such as the spacing, thickness, color, and arrangement of the ruled line and is easy to be reused and edited. That is, changing the structure of the ruled line means changing the attribute information such as the spacing of the ruled line.

According to the projector described above, since the storage processing unit makes the ruled line storage section store the edited ruled line data, that is, the modified data, corresponding to the ruled line changed by the ruled line editing unit in such a way that the modified data can be reused, it is possible to read the edited ruled line whenever necessary by referring to the ruled line storage section and project the edited ruled line thus read. This makes it easy to reuse and re-edit the generated ruled line and makes it possible to enhance the workability of ruled line generation.

According to a specific embodiment, in the projector described above, the ruled line editing unit may include an input section that accepts an operation for editing and a change processing section that changes the structure of the ruled line based on the operation for the input section. In this case, it is possible to make the change processing section change the ruled line as a result of the user operating the input section while making the ruled line reading unit display the ruled line which is being edited. This makes it easy to edit the projected ruled line.

According to another embodiment, the ruled line editing unit may change the spacing of the ruled line based on the operation input to the input section. In this case, it is possible to perform simple editing by which the spacing of the ruled line is changed by using the input section.

According to another embodiment, when a plurality of pieces of ruled line data are stored in the ruled line storage section, the ruled line reading unit may allow any one of the plurality of pieces of ruled line data to be selected for projection and editing. In this case, it is possible to store a plurality of pieces of ruled line data including the data before editing and the data after editing, and select any ruled line data that is fit for a purpose from the plurality of pieces of ruled line data and display the selected ruled line data.

According to another embodiment, the ruled line storage section may include accompanying information giving a higher priority to the data which has been used most recently or the data with the highest use frequency of the plurality of pieces of ruled line data and a ruled line list for selecting the plurality of pieces of ruled line data, and the ruled line reading unit may arrange the ruled line data in the ruled line list based on the accompanying information. In this case, it is possible to give a higher priority to the ruled line which has been used most recently or the ruled line with the highest use frequency and display the ruled line, making it possible to enhance the convenience of the display and editing of the ruled line.

According to another embodiment, the ruled line editing unit may specify part of the ruled line corresponding to the ruled line data read from the ruled line storage section, and edit the specified part. In this case, partial editing is made possible. This makes it possible to increase the variety of ruled lines to be projected by the image projecting section, and provide greater flexibility in editing the ruled line.

According to another embodiment, the ruled line editing unit may make display of specified part of the ruled line different from display of the remaining part. In this case, it is possible to recognize clearly the ruled line part which is being edited and thereby enhance the reliability and efficiency of editing operation.

According to at least one embodiment of the disclosure, there is provided a method for projecting an image by a projector provided with an image projecting section that projects an image, the method including: a reading step of reading ruled line data of ruled line from a ruled line storage section that stores the ruled line data of the ruled line so as to make the image projecting section project the ruled line corresponding to the ruled line data; an editing step of performing editing for changing the structure of the projected ruled line; and a storing step of making the ruled line storage section store the edited ruled line data corresponding to the ruled line changed in the editing step.

According to the above-described method for projecting an image, since the ruled line storage section is made to store the ruled line data corresponding to the ruled line changed in the editing step, that is, the modified data in such a way that the modified data can be reused, it is possible to read the edited ruled line whenever necessary by referring to the ruled line storage section and project the edited ruled line thus read. This makes it easy to reuse and re-edit the generated ruled line and makes it possible to enhance the workability of ruled line generation.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a diagram explaining a usage environment of a projector of an embodiment.

FIG. 2 is a block diagram showing the structure of the projector.

FIG. 3 is a diagram showing an example of key elements forming a key operation section.

FIG. 4 is a flowchart explaining the flow of processing performed in the projector.

FIG. 5 is a flowchart explaining the flow of processing performed in the projector.

FIG. 6A is a display example of a ruled line list, FIG. 6B is a display example of a ruled line image, FIG. 6C shows a state of a board surface after the user performs writing, and FIG. 6D visually shows an example of ruled line image data.

FIG. 7A shows an example of an operation change selection menu, FIG. 73 shows an example of a range selection menu, and FIG. 7C shows an example of a change item menu.

FIGS. 8A to 8J are diagrams explaining a method for changing the type and spacing of line at the same time.

FIG. 9 is a flowchart showing the flow of processing performed in the projector.

FIG. 10A shows an example of a ruled line image, FIG. 10B shows a case in which the range specified by the positions of a starting point and an endpoint is a plane region, and FIG. 10C shows a case in which the range specified by the positions of a starting point and an endpoint is a line section.

### DESCRIPTION OF EMBODIMENTS

A projector according to an embodiment of the disclosure will be described below in detail with reference to the drawings.

### A. Usage Environment of Projector

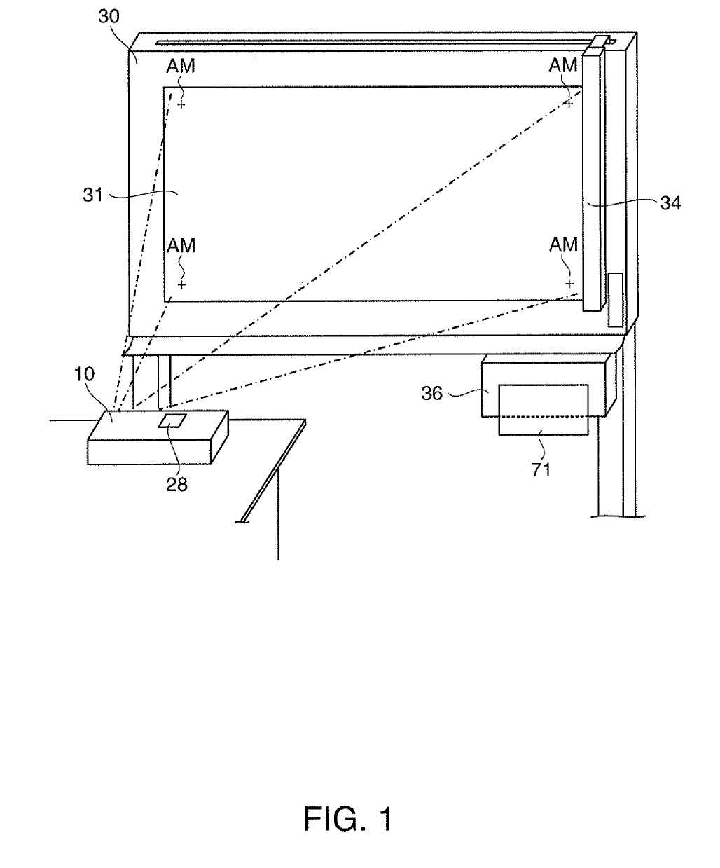

As shown in FIG. 1, a projector 10 can project various images onto a board surface 31 of a whiteboard 30 based on image data held in the projector 10 or image data obtained from the outside. The images projected by the projector 10 include a ruled line corresponding to ruled line data stored in the projector 10. By operating the projector 10, the user can edit the ruled line on the board surface 31, the ruled line projected on the board surface 31, and make the projector 10 itself store the ruled line data corresponding to the edited ruled line so that the ruled lined data can be reused.

Incidentally, in the example shown in the drawing, the whiteboard 30 is an electronic whiteboard. Images including characters, numerics, and the like, can be written on the board surface 31 with a marker pen according to the ruled line projected by the projector 10, for example. In addition, the written image read from the board surface 31 by a board reading section 34 can be printed on paper 71 by an attached printer 36.

### B. Structure of Projector

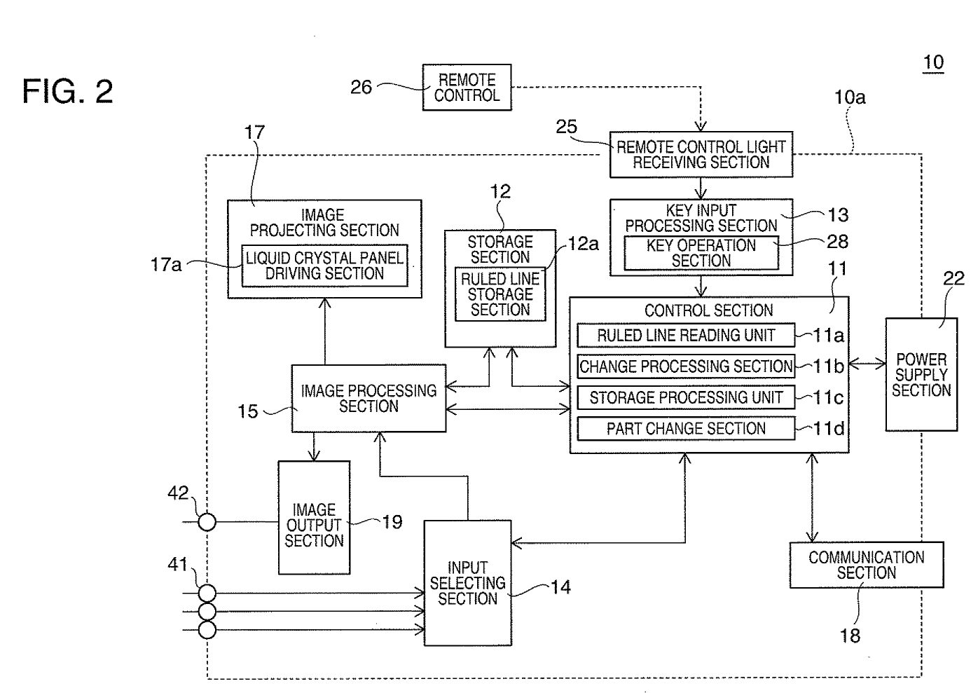

As shown in FIG. 2, the projector 10 includes, as a main body 10a thereof, a control section 11, a storage section 12, a key input processing section 13, an input selecting section 14, an image processing section 15, an image projecting section 17, a communication section 18, an image output section 19, and a power supply section 22.

The control section 11 controls the entire function of the projector 10. That is, the control section 11 is connected to the storage section 12, the key input processing section 13, the input selecting section 14, the image processing section 15, the communication section 18, the power supply section 22, etc. in such a way that the control section 11 can communicate with these sections, and controls the operation state by taking in information from these sections or sending a control signal or the like to these sections. Specifically, the control section 11 functions as a ruled line reading unit 11a, a change processing section 11b, a storage processing unit 11c, a part change section 11d, and the like. Here, the control section 11 as the change processing section 11b functions as a ruled line editing unit by cooperating with the key input processing section 13. The details of these functions will be described later.

The storage section 12 holds a program product, data, and the like which are necessary for operating the projector 10. Moreover, the storage section 12 also holds image data corresponding to a projection image to be projected by the image projecting section 17. The image data includes ruled line data which becomes necessary when a ruled line is projected, specifically, data on attribute information or elemental information, such as the spacing, thickness, color, arrangement, etc. of the ruled line. The storage section 12 can store, in addition to the image data held by the projector 10 or edited by the projector 10, image data or an image signal which is taken in from the outside via the communication section 18, the input selecting section 14, or the like.

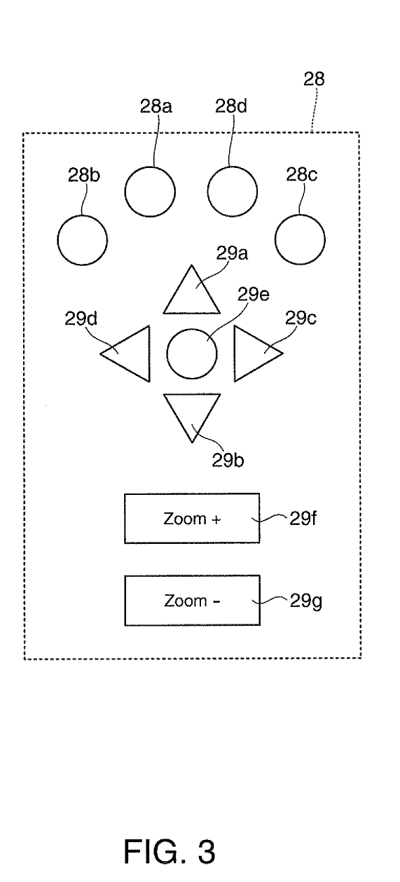

The key input processing section 13 is an input section for inputting an instruction from the user, and has a key operation section 28 including a set of operation keys. The key input processing section 13 may have a display as a UI. The key input processing section is accompanied with a remote control light receiving section 25, whereby it is possible to receive a command signal remotely from a remote control 26 wirelessly. Incidentally, as shown in FIG. 3, the key operation section 28 is provided with, as a set of operation keys, a power button 28a, a menu button 28b, an escape button 28c, an input switching button 28d, triangular buttons 29a, 29b, 29c, and 29d representing four directions, an Enter button 29e, two zoom buttons 29f and 29g, etc. in an appropriate arrangement. These buttons 28a, 28b, 28c, 29a, 29b, 29c, 29d, 29e, 29f, and 29g, that is, a set of operation keys, can be provided not only in the key operation section 28, but also in the remote control 26. In that case, it is possible to reduce the number of operation keys or buttons provided in the key operation section 28.

The input selecting section 14 is provided for selecting, from among unillustrated computer, disk player, and other image output devices (not shown) connected to a connector 41, the device from which the input selecting section 14 receives an image signal, and can switch the input image signal as a result of the input switching button 28d being pressed.

The image processing section 15 can perform various corrections including color correction, shift correction, magnification correction, and distortion correction on the image signal or image data input from the outside via the input selecting section 14 or the communication section 18. Moreover, the image processing section 15 can generate an image signal for displaying character information, a ruled line, and the like, instead of the image signal etc. input from the outside or by being superimposed on the image signal etc. input from the outside, from the image data fetched from the storage section 12 based on the instruction from the control section 11. The image projecting section 17 has a liquid crystal panel driving section 17a driving a liquid crystal panel for RGB colors based on the image signal subjected to the image processing, the image signal output from the image processing section 15. Though not described specifically, the image projecting section 17 includes as an optical system, for example, an illuminating device, a liquid crystal panel for RGB colors, a combining prism, a projecting lens, and the like, and displays a color image on the board surface 31 of the whiteboard 30 of FIG. 1 by combining the lights which have passed through a liquid crystal light valve for RGB colors, the liquid crystal light valve formed of the liquid crystal panel, and projecting the combined light. Incidentally, the optical system of the image projecting section 17 is not limited to a liquid crystal system, but may be any one of various systems such as a digital micromirror device system, an LCOS system, a GLV system, and a CRT system.

The communication section 18 is an interface circuit that makes communication possible. Incidentally, the communication section 18 can be configured as a wireless interface circuit that makes communication by, for example, an ad-hoc mode of a wireless LAN possible. In this case, the communication section 18 can establish a peer-to-peer connection with network-connected devices including a computer. Furthermore, the communication section 18 can also be configured as a wired interface circuit which is connected to a wired LAN or the like.

The image output section 19 is provided for sharing image data such as ruled line data generated by the projector 10 with another projector, and can be connected directly or indirectly to the other projector via a connector 42.

Incidentally, the power supply section 22 operates under control of the control section 11, and supplies power to individual parts of the projector 10.

### C. Operation of Projector

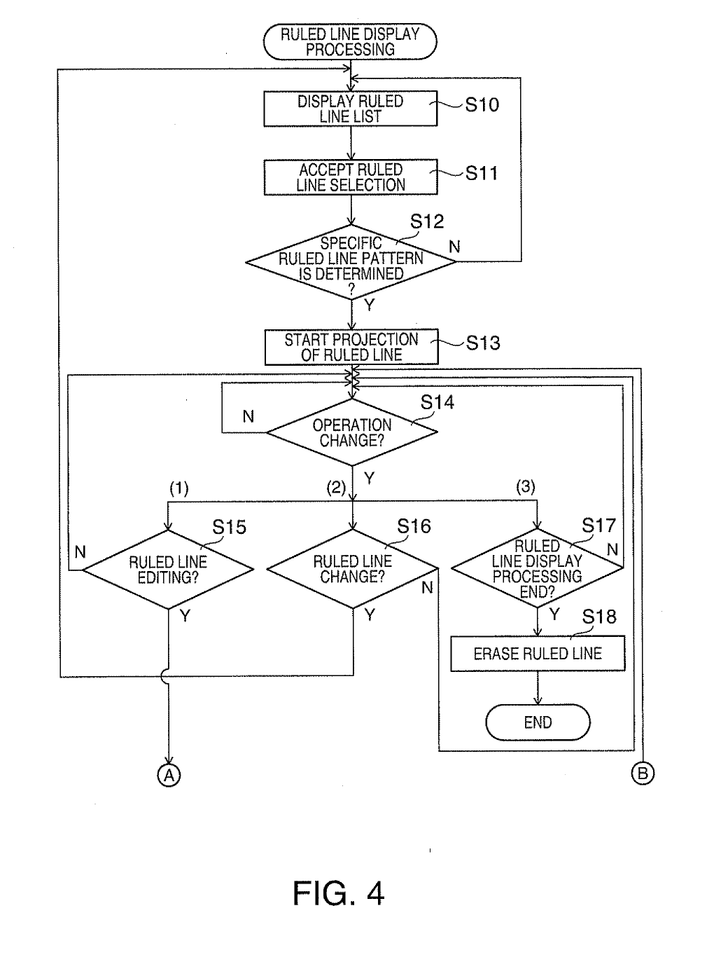

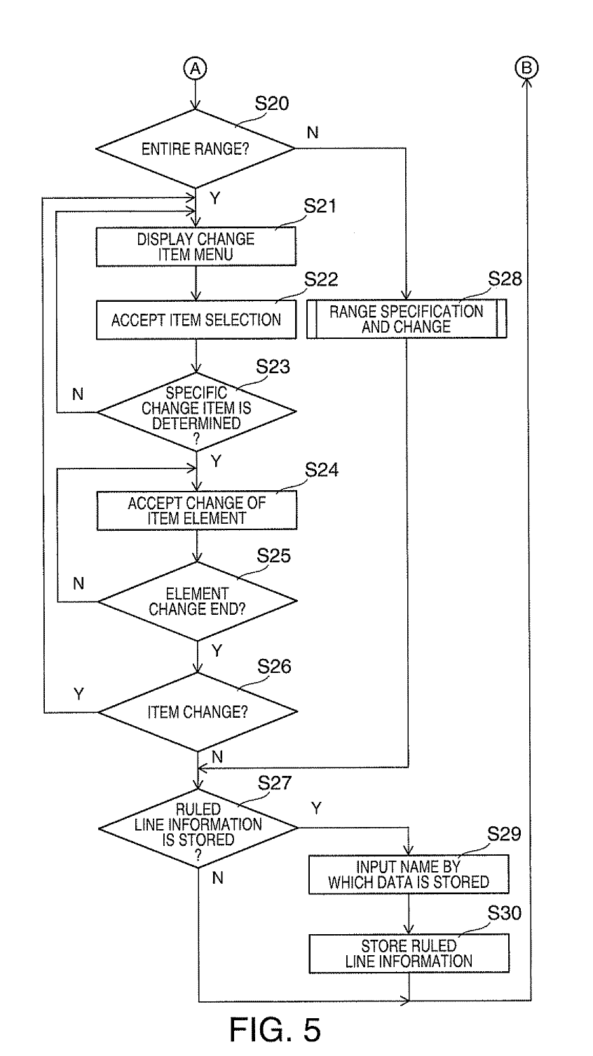

Hereinafter, an example of ruled line projection operation performed by the projector 10 will be described with reference to FIGS. 4 and 5 and other drawings. When the direction signal detected by the key input processing section 13 is a signal requesting start of ruled line display processing, the control section 11 of the projector 10 starts the ruled line display processing described below. Specifically, when the user displays a menu screen by using the menu button 28b or the like of the key operation section 28 and selects ruled line display item in the menu, the control section 11 starts the ruled line display processing by which the ruled line can be projected, edited, stored, etc.

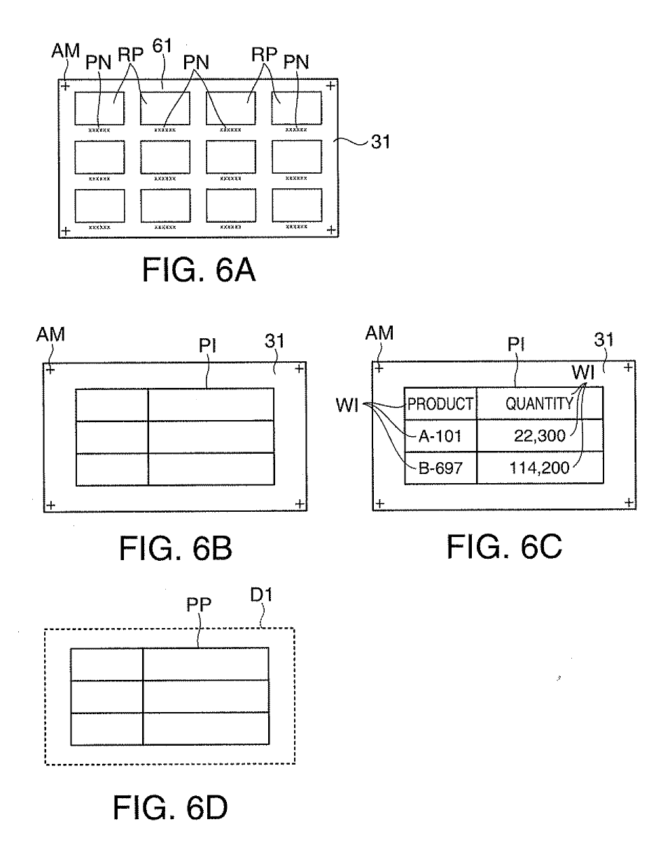

First, as shown in FIG. 4, the control section 11 selects display data for a ruled line list display menu, the display data stored in a ruled line storage section 12a of the storage section 12, as image data to be provided to the image processing section 15, and makes the image projecting section 17 project a corresponding menu image via the image processing section 15 or the like (step S10). FIG. 6A shows an example of a ruled line list display menu 61. A plurality of ruled line patterns RP displayed as a ruled line list in the menu include not only ruled line patterns corresponding to the ruled line data originally stored in the ruled line storage section 12a as a template, but also edited ruled line data (that is, modified data) which has been changed by editing, which will be described later, and added to the ruled line storage section 12a. In other words, the ruled line storage section 12a stores a plurality of pieces of ruled line data including original ruled line data and edited ruled line data. Predetermined accompanying information is attached to each ruled line data, and a ruled line name PN extracted from the accompanying information is displayed under the ruled line pattern RP. Moreover, the accompanying information includes information on priorities, whereby it is possible to give a higher priority to the data which has been used most recently or the data with the highest use frequency of the plurality of pieces of ruled line data, and arrange the data in the upper part of the ruled line list.

By selecting a specific ruled line pattern RP from the ruled line list display menu 61 of FIG. 6A by using the triangular buttons 29a, 29b, and the like, of the key operation section 28 provided in the key input processing section 13, the user chooses which ruled line of the ruled lines stored in the ruled line storage section 12a of the storage section 12 is to be projected (step S11). If the user determines a specific ruled line pattern RP by operating the Enter button 29e of the key operation section 28 (step S12: Y), as the ruled line reading unit 11a performing a projecting step, the control section 11 makes a request to the storage section 12 for the ruled line data corresponding to the ruled line pattern RP arbitrarily selected and determined by the user and reads the ruled line data from the ruled line storage section 12a, and makes the image processing section 15 generate pattern data which is the ruled line data converted into a pattern (step S13). With the execution of step S13, the image processing section 15 makes the image projecting section 17 project the ruled line pattern corresponding to the pattern data, that is, the ruled line image. Incidentally, the image processing section 15 performs misregistration correction processing on the projection image, and, in this misregistration correction processing, image processing for optimizing the projection position based on a correction parameter necessary for coordinate conversion including shift correction, magnification correction, distortion correction, and the like. As a result, the ruled line image projected on the board surface 31 has become a distortion-free image which falls within a rectangular reference region surrounded by four alignment marks AM on the board surface 31 shown in FIG. 1.

FIG. 6B shows an example of a display state of the board surface 31 on which projection is performed by the projector 10, that is, a projected ruled line image PI. FIG. 6C shows an example of a display state of the board surface 31 after the user performs writing on the board surface 31 with a marker pen, that is, a written image WI. In this case, the written image WI is a character or a numeric value which is written in such a way as to be embedded in the space of the ruled line image PI. FIG. 6D corresponds to the ruled line image PI of FIG. 6B, and visually shows an example of ruled line image data D1 having a ruled line part PP. The ruled line image data D1 holds the attribute information on the spacing, thickness, color, arrangement, and the like, of the ruled line part PP as digitized information.

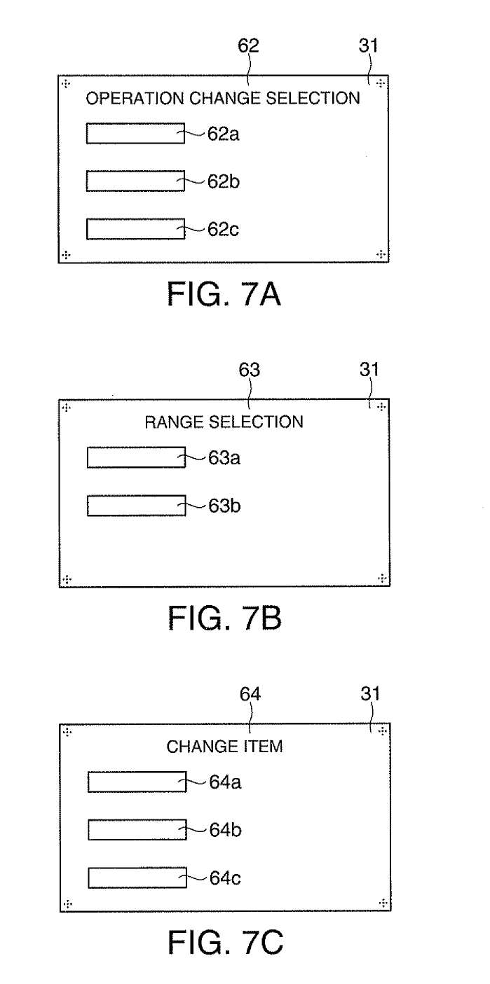

Back in FIG. 4, when the user then operates the menu button 28b or the like of the key operation section 28, the control section 11 makes a request to the storage section 12 for display data for an operation change selection menu, and makes the image projecting section 17 project a corresponding menu image via the image processing section 15 or the like (step S14). As shown in FIG. 7A, in the projected operation change selection menu 62, a ruled line editing button 62a for changing the details of the ruled line, a ruled line change button 62b for replacing the ruled line with another ruled line, and a ruled line erase button 62c for ending the ruled line display processing are displayed. If the user selects the ruled line editing button 62a (step S14: Y(1), S15), the control section 11 performs ruled line editing operation, which will be described later, as the change processing section 11b. If the user selects the ruled line change button 62b (step S14: Y(2), S16), the procedure goes back to step S10, and the control section 11 makes the image projecting section 17 project a ruled line list display menu image. If the user selects the ruled line erase button 62c (step S14: Y(3), S17), the control section 11 erases the ruled line data from the image processing section 15, and ends projection of the ruled line image performed by the image projecting section 17 (step S18). That is, the control section 11 ends the ruled line display processing, and returns to a normal display mode.

Hereinafter, the ruled line editing operation (editing step) will be described in detail. If the user selects the ruled line editing button 62a (step S14: Y(1), S15), the control section 11 makes a request to the storage section 12 for display data for a range selection menu for specifying the range of ruled line editing, and makes the storage section 12 transfer the display data to the image processing section 15. The image processing section 15 makes the image projecting section 17 project a menu image corresponding to the display data (step S20). As shown in FIG. 7B, in the range selection menu 63, an entire range specification button 63a for editing the entire range of the projected ruled line and a part specification button 63b for editing part of the range of the ruled line are displayed. If the user selects the part specification button 63b (step S20: N), the control section 11 performs range specification and change processing, which will be described later (step S28). If the user selects the entire range specification button 63a (step S20: Y), the control section 11 makes a request to the storage section 12 for display data for a change item menu for specifying a ruled line editing item, and makes the image projecting section 17 project a menu image corresponding to the display data via the image processing section 15 or the like (step S21). As shown in FIG. 7C, in a change item menu 64, a color change button 64a, a line type change button 64b, and a line spacing change button 64c, for example, are displayed. The user chooses any change item from the projected change item menu 64 by using the key operation section 28 of the key input processing section 13 (step S22). If the user determines a specific change item (step S23: Y), the control section 11 accepts the input information of the key operation section 28 as the change processing section 11b, and converts the input information into direction information of the change item. Based on the direction information accepted as the change processing section 11b, the control section 11 calls the ruled line data again, the ruled line data which is being displayed and is stored in the ruled line storage section 12a of the storage section 12, and performs conversion processing on the attribute information or elemental information (specifically, a data part on the color, line type, arrangement, and the like) of the ruled line. In other words, the control section 11 performs editing for changing the structure of the ruled line based on the operation input to the key operation section 28, that is, the input information. Then, the control section 11 transmits the converted ruled line data to the image processing section 15, and makes the image processing section 15 generate pattern data. The image processing section 15 makes the image projecting section 17 project a ruled line image corresponding to the pattern data (step S24). That is, based on the key input from the user via the key input processing section 13, the control section 11 performs adjustment processing on the selected and determined change item, the adjustment processing by which the attribute of the ruled line is corrected, and changes a corresponding element of the ruled line image displayed before the direction by the key input from the user is accepted and thereby obtains a ruled line image corresponding to the direction. For example, if the user selects the color change button 64a by using the key operation section 28 of the key input processing section 13, the control section 11 makes a request to the storage section 12 for display data for a palette-like color selection screen in which a plurality of colors are placed in partitioned segments and makes the storage section 12 transfer the display data to the image processing section 15, and makes the image projecting section 17 project a color selection image via the image processing section 15. As the change processing section 11b, the control section 11 determines that the triangular buttons 29a, 29b, 29c, and 29d arranged on the key operation section 28 indicate up, down, right, and left movements, respectively, in the color segments of the color selection screen. A color is selected every time the user operates any one of the triangular buttons 29a, 29b, 29c, and 29d of the key operation section 28, and the control section 11 changes the color of the target ruled line data and changes the color of the projected ruled line to the selected color. Moreover, if the user selects the line type change button 64b by using the key operation section 28 of the key input processing section 13, the control section 11 determines, as the change processing section 11b, that the operations by the triangular buttons 29a, 29b, 29c, and 29d provided in the key operation section 28 indicate a change of the line type. Every time the user presses any one of the triangular buttons 29a, 29b, 29c, and 29d of the key operation section 28, the control section 11 changes the line type of the target ruled line data and changes the thickness or pattern of the projected ruled line. Furthermore, if the user selects the line spacing change button 64c by using the key operation section 28 of the key input processing section 13, the control section 11 determines, as the change processing section 11b, that the operation by the triangular button 29a of the key operation section 28 indicates the widening of the row spacing of the ruled line, the operation by the triangular button 29b indicates the reduction of the row spacing of the ruled line, the operation by the triangular button 29c indicates the widening of the column spacing of the ruled line, and the operation by the triangular button 29d indicates the reduction of the column spacing of the ruled line. As described above, every time the user operates any one of the buttons 29a, 29b, 29c, and 29d of the key operation section 28, the control section 11 gradually changes the target ruled line data about the spacing of the ruled line, and thereby gradually changes the spacing of the line forming the projected ruled line.

Incidentally, the above-described ruled line editing processing is a mere example, and the line type and the spacing can be changed concurrently in the same mode. In this case, for example, the row spacing of the ruled line is widened by the triangular button 29a, the row spacing of the ruled line is reduced by the triangular button 29b, the column spacing of the ruled line is widened by the triangular button 29c, and the column spacing of the ruled line is reduced by the triangular button 29d. Moreover, the line thickness is increased by pressing the Enter button 29e for a short time, and, by repeating the above operation, the line thickness is gradually increased. When the line thickness reaches the maximum thickness, the line thickness switches to the minimum thickness, and the line thickness is gradually increased again. Furthermore, the row spacing and column spacing of the ruled line are collectively widened gradually by pressing the zoom button 29f, and the row spacing and column spacing of the ruled line are collectively reduced gradually by pressing the zoom button 29g.

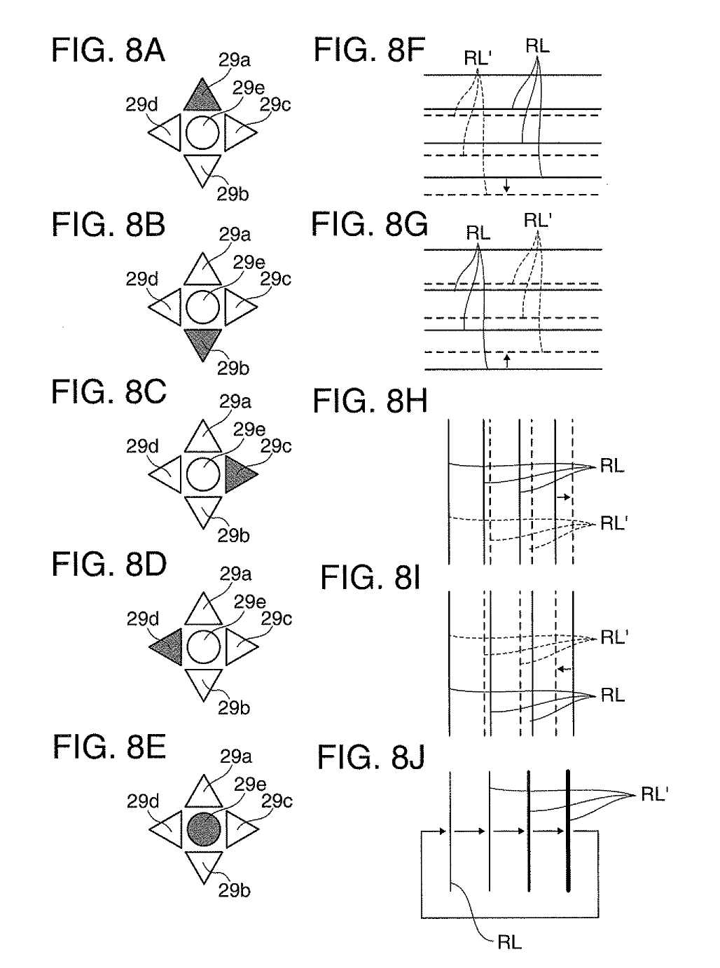

FIGS. 8A to 8J are diagrams specifically explaining a method for changing the line type and the spacing at the same time. By pressing the triangular button 29a as shown in FIG. 8A, it is possible to change a projected original ruled line RL to a new ruled line RL′ by widening the row spacing of the original ruled line RL as shown in FIG. 8F. By pressing the triangular button 29b as shown in FIG. 8B, it is possible to change a projected original ruled line RL to a new ruled line RL′ by reducing the row spacing of the original ruled line RL as shown in FIG. 8G. By pressing the triangular button 29c as shown in FIG. 8C, it is possible to change a projected original ruled line RL to a new ruled line RL′ by widening the column spacing of the original ruled line RL as shown in FIG. 8H. By pressing the triangular button 29d as shown in FIG. 8D, it is possible to change a projected original ruled line RL to a new ruled line RL′ by reducing the column spacing of the original ruled line RL as shown in FIG. 8I. Furthermore, by pressing the Enter button 29e for a short time as shown in FIG. 8E, it is possible to change a projected original ruled line RL to a new ruled line RL′ by gradually increasing the thickness of the original ruled line RL as shown in FIG. 8J. Incidentally, though not shown in the drawing, by pressing the zoom button 29f of FIG. 3, the widening in FIG. 8F and the widening in FIG. 8H are performed concurrently, whereby it is possible to widen the row spacing and the column spacing collectively. Moreover, by pressing the zoom button 29g of FIG. 3, the reduction in FIG. 8G and the reduction in FIG. 8I are performed concurrently, whereby it is possible to reduce the row spacing and the column spacing collectively.

Back in FIG. 5, after step S24, when the user presses the Enter button 29e, the control section 11 ends the acceptance of change operation, and keeps projection of the changed ruled line image (step S25: Y). Then, the control section 11 makes the image projecting section 17 project a confirmation screen asking whether there is an item change or not via the image processing section 15 (step S26). If the user requests an item change by pressing the Enter button 29e (step S26: Y), the procedure goes back to step S21, and the control section 11 makes the image projecting section 17 project a menu image corresponding to a change item menu. If the user requests end of an item change by pressing, for example, the escape button 28c (step S26: N), the control section makes the image projecting section 17 project confirmation screen asking whether the ruled line data is stored or not via the image processing section 15 (step S27). If the user does not store the ruled line data (step S27: N), the procedure goes back to step S14, and the operation change selection menu is displayed. If the user stores the ruled line data (step S27: Y), the control section 11 makes a request to the storage section 12 for display data for a key arrangement display image for inputting a name by which the data is stored, and makes the storage section 12 transfer the display data to the image processing section 15. Under the control of the control section 11, the image processing section 15 makes the image projecting section 17 project the character key arrangement display image. The user selects a specific name by which the data is stored, that is, a ruled line name, from the projected character key arrangement table by using the key operation section 28 of the key input processing section 13 (step S29). As the storage processing unit 11c, the control section 11 relates the ruled line name obtained via the key input processing section 13 to the changed ruled line data, and stores them in the ruled line storage section 12a of the storage section 12 (step S30). The stored edited ruled line is ruled line data, and is reused as one of the ruled line patterns RP forming the ruled line list display menu 61 of FIG. 6A. The above-described steps S29, S30, or the like is a storing step for storing the edited ruled line. Incidentally, when the ruled line data is stored in the ruled line storage section 12a of the storage section 12, the accompanying information corresponding to the ruled line data is updated. This accompanying information includes information on priorities such as the update time, the latest access time, and the access frequency as information other than a ruled line name, and such information is used for arrangement reconfiguration when the ruled line list display menu 61 is next displayed.

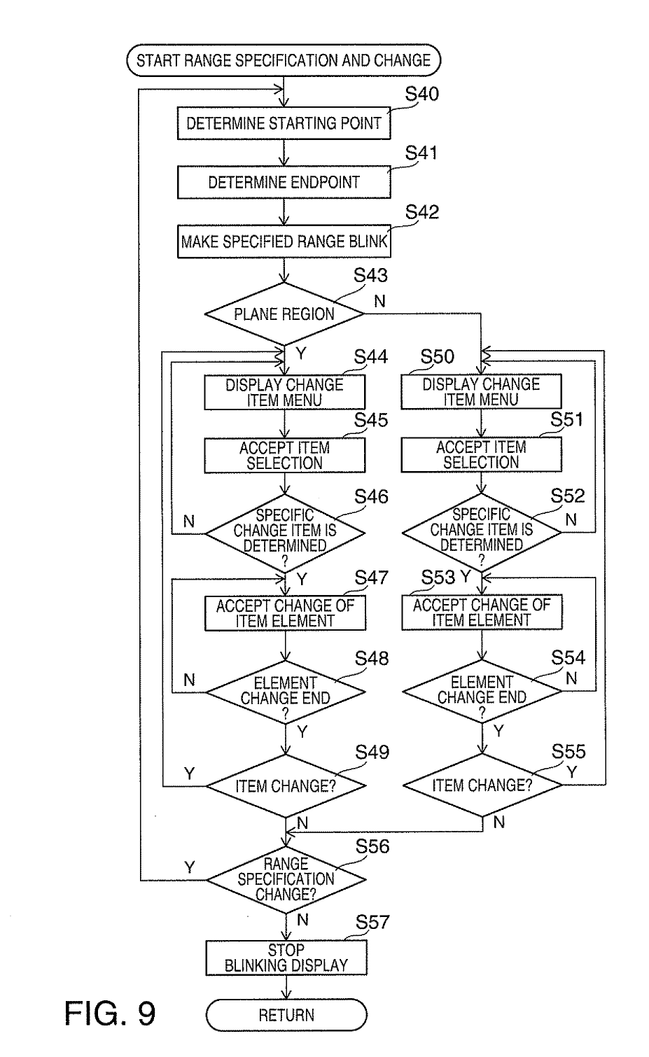

Hereinafter, range specification and change operation in step S28 of FIG. 5 will be described with reference to FIG. 9. As described above, if the user selects the part specification button (step S20: N), the control section 11 starts range specification and change processing as the part change section 11d.

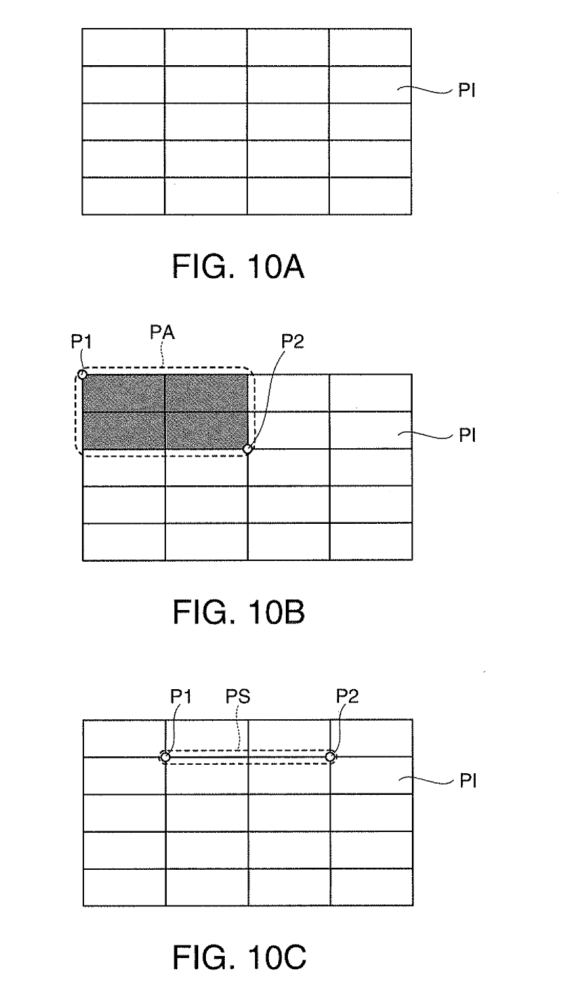

The control section 11 determines a range to be specified in the projected ruled line based on a starting point and an endpoint which are selected by the user from the previously set points on a grid. Specifically, the mode is first in a starting point specifying mode, and the control section 11 makes the image projecting section 17 project a cursor indicating a position on the board surface 31. When the user presses any one of the triangular buttons 29a, 29b, 29c, and 29d arranged on the key operation section 28, the cursor is moved to a corresponding one of the periodical positions on the grid of the projected ruled line. When the user presses the Enter button 29e in any grid position, the control section 11 determines the position of a starting point of range specification, and holds the position as coordinate information (step S40). At this time, the mode switches into an endpoint specifying mode. Furthermore, when the user presses any one of the triangular buttons 29a, 29b, 29c, and 29d to move the cursor, and presses the Enter button 29e at any grid position, the control section 11 determines an endpoint position of range specification, and holds the position as coordinate information (step S41). Then, the control section 11 makes the image projecting section 17 perform projection via the image processing section 15 in such a way that the region or section defined by the starting point and the endpoint blinks (step S42). At this time, since the remaining part is in normal non-blinking display, blinking display makes it obvious that the specified part of the ruled line is being edited. When range specification is performed on a ruled line image PI shown in FIG. 10A, the control section 11 determines whether the range specified by the positions of a starting point P1 and an endpoint P2 is a plane region. PA shown in FIG. 10B or a line section PS shown in FIG. 10C (step S43). If the specified range is the plane region PA (step S43: Y), the control section 11 performs operations in step S44 and the steps that follow. If the specified range is the line section PS (step S43: N), the control section 11 performs operations in step S50 and the steps that follow.

If the specified range is the plane region (step S43: Y), the control section 11 makes a request to the storage section 12 for display data corresponding to a change item menu for specifying a ruled line editing item, and makes the image projecting section 17 project a menu image corresponding to the display data via the image processing section 15 or the like (step S44). As in the case of step S21, in the change item menu 64, the color change button 64a, the line type change button 64b, and the line spacing change button 64c are displayed (see FIG. 7C). The user selects any change item from the projected change item menu by using the key operation section 28 of the key input processing section 13 (step S45). If the user determines a specific change item (step S46: Y), the control section 11 accepts the input information of the key operation section 28, and converts the input information into direction information of the change item. Based on the accepted direction information, the control section 11 calls the ruled line data which is being displayed and is stored in the ruled line storage section 12a of the storage section 12, and performs conversion processing on the attribute (specifically, a data part on the color, line type, arrangement, and the like) of the ruled line in the specified plane region. Thereafter, the control section 11 transmits the locally converted ruled line data to the image processing section 15, and makes the image processing section 15 generate pattern data. The image processing section 15 makes the image projecting section project a ruled line image corresponding to the pattern data (step S47). For example, if the user selects the color change button 64a by using the key operation section 28 of the key input processing section 13, as in the case of step S24, the control section 11 changes the color of a part corresponding to the specified local region of the ruled line data in accordance with the key operation by the user, and changes the color of the projected ruled line to the selected color. Moreover, if the user selects the line type change button 64b by using the key input processing section 13, as in the case of step S24, the control section 11 changes the line type of a part corresponding to the specified local region of the ruled line data in accordance with the key operation by the user, and changes the thickness or pattern of the projected ruled line. In addition, if the user selects the line spacing change button 64c by using the key input processing section 13, as in the case of step S24, the control section 11 changes the line spacing of a part corresponding to the specified local region of the ruled line data in accordance with the key operation by the user, and changes the line spacing of the projected ruled line.

After step S47, when the user presses the Enter button 29e, the control section 11 ends the acceptance of change operation, and keeps projection of the changed ruled line image (step S48: Y). Then, the control section 11 makes the image projecting section 17 project a confirmation screen asking whether there is an item change or not via the image processing section 15 (step S49). If the user requests an item change (step S49: Y), the procedure goes back to step S44, and the control section 11 makes the image projecting section 17 project a selection image corresponding to a change item menu. If the user requests end of an item change (step S49: N), the control section 11 makes the image projecting section project a confirmation screen asking whether the specified range is changed or not via the image processing section 15 (step S56). If the user changes the specified range (step S56: Y), the procedure goes back to step S40. If the user does not change the specified range (step S56: N), the control section 11 makes the image projecting section 17 stop blinking display via the image processing section 15 (step S57).

Moreover, if the specified range is the line section (step S43: N), as in the case of plane region specification, as the part change section 11d, the control section 11 makes a request to the storage section for display data corresponding to a change item menu for specifying a ruled line editing item, and makes the image projecting section 17 project a menu image corresponding to the display data via the image processing section 15 or the like (step S44), a change item is selected and determined according to the direction from the user (steps S51 and S52), and an element of the item is changed (step S53). Incidentally, if the line section is specified, line delete and addition buttons are displayed in the change item menu instead of the line spacing change button. For example, if the user selects a line delete button or addition button by using the key operation section 28 of the key input processing section 13, the control section 11 determines that line deletion or addition is directed when the Enter button 29e provided in the key operation section 28 is pressed. Every time the user presses the Enter button 29e of the key operation section 28, the control section 11 makes changes to delete or add a line in the specified section. After step S53, as in the case of plane region specification (steps S48 and S49), the control section 11 ends the acceptance of change operation (step S54: Y), and, if the user changes an item (step S55: Y), the procedure goes back to step S50. On the other hand, if the user does not change an item (step S50: N), the control section 11 performs operations in step S56 and steps that follow.

As described above, according to the projector 10 of this embodiment, since the storage processing unit 11c of the control section 11 makes the ruled line storage section 12a of the storage section 12 store the edited ruled line data, that is, the modified data, corresponding to the ruled line changed by the change processing section 11b of the control section 11 in such a way that the modified data can be reused, it is possible to read the edited ruled line whenever necessary by referring to the ruled line storage section 12a and project the edited ruled line thus read. This makes it easy to reuse and re-edit the generated ruled line and makes it possible to enhance the workability of ruled line generation.

### Modified Examples and Others

While the invention has been described in connection with the embodiment, the invention is not limited to the embodiment described above, and various changes can be made therein without departing from the spirit of the invention. For example, the following modifications are possible.

In the embodiment described above, an example in which a grid composed of straight horizontal lines and vertical lines is projected as a ruled line has been described. However, it is also possible to make the projector 10 of this embodiment project a ruled line composed only of a horizontal line or a vertical line onto the whiteboard 30, edit the projected ruled line, and store the edited ruled line. Moreover, as a kind of ruled line, a graphic such as a circle or an ellipse can also be projected by the projector 10 of this embodiment. In this case, it is possible to edit the projected graphic such as a circle or an ellipse and store the edited projected graphic in such a way that the edited projected graphic can be reused.

In the embodiment described above, a ruled line is selected from the ruled line list display menu 61; however, the embodiment may be modified so that ruled lines with high use frequency are registered in advance such that the ruled lines can be called directly. For example, by pressing the zoom buttons 29f and 29g one after another, it is possible to read the registered ruled lines one after another and project the ruled line thus read while switching the ruled lines, and store the ruled line after editing the ruled line.

In the embodiment described above, a ruled line is selected from the ruled line list display menu 61; however, the embodiment may be modified so that the ruled lines can be called one after another by pressing the input switching button 28d. That is, every time the input switching button 28d is pressed, the ruled lines registered in a computer, a disk player, other image output devices, and the ruled line storage section 12a can be switched one after another and projected.

The ruled line image projected on the whiteboard 30 by the projector 10 of the embodiment described above can be transmitted as data to the whiteboard 30 via an appropriate communication unit such as the communication section 18. In this case, the whiteboard 30 can make the printer 36 of the whiteboard 30 print a combined image of the ruled line image PI and the written image WI which are shown in FIG. 6C. Conversely, the written image WI read by the board reading section 34 of the whiteboard 30 can be captured in the projector 10. In this case, it is possible to store the combined image of the ruled line image PI and the written image WI in the projector 10 and project the combined image onto the whiteboard 30 or the like.

In the embodiment described above, a higher priority is given to the usage history or use frequency when the ruled line patterns RP are arranged and displayed in the ruled line list display menu 61; however, the ruled line patterns RP can be arranged in order of ruled line name PN. Moreover, a ruled line pattern RP corresponding to the ruled line data which is originally stored in the ruled line storage section 12a as a template and a ruled line pattern RP corresponding to the edited ruled line data (that is, the modified data) added to the ruled line storage section 12a can be grouped and arranged.

In the embodiment described above, the original ruled line data and the edited ruled line data are stored in the ruled line storage section 12a of the storage section 12. Instead, the ruled line data generated in the outside can also be captured in the ruled line storage section 12a as a template or the like by using the communication section 18 or the like and stored therein.

In the embodiment described above, the attributes of the ruled line, such as the color, the line type, and the arrangement, are edited. However, all of these attributes do not have to be made editable. For example, only the attributes on the line type, the arrangement, and the like, other than the color may be made editable.

In the embodiment described above, the color, the line type, and the line spacing are changed when ruled line editing of the selected plane region is performed. However, the ruled line elements in the plane region can be deleted collectively, or is also possible to perform processing by which prepared ruled line data or ruled line material image is embedded in the selected plane region.

In the embodiment described above, the plane region PA and the line section PS which are specified based on the positions of a starting point and an endpoint are blinked. However, various kinds of display for identification are possible, such as by increasing the brightness of the specified region or section or making a shadow therein so that the specified region or section differs from the remaining part, or the brightness of the remaining part is reduced.

In the embodiment described above, projecting and editing a graphic ruled line has been described. However, editing such as changing the attribute of a ruled line can also be performed on the ruled line data subjected to combining processing by which a background image or an accompanying image which is input via the input selecting section 14, for example, is superimposed on a ruled line image to be projected. The ruled line data subjected to such editing can be stored in the ruled line storage section 12a.

In the description above, the ruled line list display menu 61, the operation change selection menu 62, the range selection menu 63, and the change item menu 64 are mere examples, and various menu displays are possible. Moreover, it is not necessary to project the menu display onto the entire area of the board surface 31 of the whiteboard 30, and the menu display can be projected onto part of the board surface 31.

What is claimed is:

1. A projector comprising:
an image projecting section that projects an image;
a ruled line storage section that stores ruled line data of a ruled line;
a ruled line reading unit that reads the ruled line data of the ruled line from the ruled line storage section so as to make the image projecting section project the ruled line corresponding to the ruled line data;
a ruled line editing unit that performs editing for changing the structure of the projected ruled line; and
a storage processing unit that makes the ruled line storage section store the edited ruled line data corresponding to the ruled line changed by the ruled line editing unit.

2. The projector according to claim 1, wherein
the ruled line editing unit includes an input section that accepts an operation for editing and a change processing section that changes the structure of the ruled line based on the operation for the input section.

3. The projector according to claim 2, wherein
the ruled line editing unit changes the spacing of the ruled line based on the operation input to the input section.

4. The projector according to claim 2, wherein
the ruled line editing unit changes the thickness of the ruled line based on the operation input to the input section.

5. The projector according to claim 1, wherein
when a plurality of pieces of ruled line data are stored in the ruled line storage section, the ruled line reading unit allows any one of the plurality of pieces of ruled line data to be selected for projection and editing.

6. The projector according to claim 5, wherein
the ruled line storage section includes accompanying information giving a higher priority to the data which has been used most recently or the data with the highest use frequency of the plurality of pieces of ruled line data and a ruled line list for selecting the plurality of pieces of ruled line data, and
the ruled line reading unit arranges the ruled line data in the ruled line list based on the accompanying information.

7. The projector according to claim 1, wherein
the ruled line editing unit specifies part of the ruled line corresponding to the ruled line data read from the ruled line storage section, and edits the specified part.

8. The projector according to claim 6, wherein
the ruled line editing unit makes display of specified part of the ruled line different from display of the remaining part.

9. A method for projecting an image by a projector provided with an image projecting section that projects an image, the method comprising:
a reading step of reading ruled line data of ruled line from a ruled line storage section that stores the ruled line data of the ruled line so as to make the image projecting section project the ruled line corresponding to the ruled line data;
an editing step of performing editing for changing the structure of the projected ruled line; and
a storing step of making the ruled line storage section store the edited ruled line data corresponding to the ruled line changed in the editing step.

10. The method according to claim 9, wherein
the editing step includes:
an input step of accepting an operation for editing; and
a change processing step for changing the structure of the ruled line based on the operation input at the input step.

11. The method according to claim 10, wherein
the editing step changes the spacing of the ruled line based on the operation input in the input step.

12. The method according to claim 10, wherein
the editing step changes the thickness of the ruled line based on the operation input in the input step.

13. The method according to claim 9, wherein
when a plurality of pieces of ruled line data are stored in the ruled line storage section, the reading step allows any one of the plurality of pieces of ruled line data to be selected for projection and editing.

14. The method according to claim 13, wherein
the ruled line storage section includes accompanying information giving a higher priority to the data which has been used most recently or the data with the highest use frequency of the plurality of pieces of ruled line data and a ruled line list for selecting the plurality of pieces of ruled line data, and
the reading step arranges the ruled line data in the ruled line list based on the accompanying information.

15. The method according to claim 9, wherein
the editing step specifies part of the ruled line corresponding to the ruled line data read from the ruled line storage section, and edits the specified part.

16. The method according to claim 14, wherein
the editing step makes display of specified part of the ruled line different from display of the remaining part.
